(19) United States
(12) Patent Application Publication
(10) Pub. No.: US 2010/0102087 A1
(43) Pub. Date: Apr. 29, 2010

(54) DISPOSABLE BEVERAGE-DISPENSING PACKAGE

(76) Inventors: Klaus Meike, Wilnsdorf-Rinsdorf (DE); Kasper Van Der Wiel, Delft (NL); Stefan Nadenau, Burbach (DE); Bernd Schrepfer, Daaden (DE)

Correspondence Address: K.F. ROSS P.C., 5683 RIVERDALE AVENUE, SUITE 203 BOX 900, BRONX, NY, 10471-0900, US

(21) Appl. No.: 12/524,224

(22) PCT Filed: Jan. 17, 2008
(86) PCT No.: PCT/EP2008/000318

§ 371 Date: Aug. 20, 2009

(30) Foreign Application Priority Data
Jan. 25, 2007 (DE) 10 2007 004 669.5
Aug. 1, 2007 (DE) 10 2007 036 469.7

(51) Int. Cl. B65D 35/56; B67D 7/78; B65D 83/00

(52) U.S. Cl. 222/105; 222/143; 222/400.7

(57) ABSTRACT

The invention relates to a beverage pouring device in the form of a disposable barrel for the compressed-gas operated pouring of beverages such as beer, wine and soft drinks that are kept at drinking temperature, e.g. using compressed CO₂. Said device consists of a multi-part container (100), a safety fitting (8) located on top of the container, a fitting pipe (10) that is immersed in the container interior and a detachable tap head that can be placed on the safety fitting or a connection piece that can be placed on said fitting during the filling process. When a lever is actuated, the head or piece displaces a seal that is situated in an external housing of the safety fitting, said housing connecting the safety fitting to the container body, downwards against an elastic force into a position that opens the liquid channel for the liquid beverage that rises via the fitting pipe. The device also optionally comprises a base and top ring. The aim of the invention is to achieve a simpler, less expensive construction using sheet steel, with an anti-corrosion protection which nevertheless complies with food safety and hygiene standards, whilst at the same time providing variable connection techniques during the filling and pouring process by means of the safety fitting (8). To achieve these aims, the safety fitting together with a liner (9; 9a) that is located in the interior of the container to protect the inner wall of the container (100), consist of a sterile material.

The invention relates to a disposable beverage-dispensing package for compressed gas-operated, e.g. with CO₂, compressed gas, dispensing of beverages, such as beer, wine, and soft drinks that have been cooled to drinking temperature, comprising a multipart container, a safety fitting on the top of the container, a fitting tube that extends down inside the container, and a removable tap head that can be attached to the safety fitting or a connector that can be attached during filling, and that, when a lever is actuated, moves a seal downward in an outer housing of the safety fitting, via which housing the safety fitting is connected to the container body, against a spring that is movable relative to the fitting tube, into a position that frees the liquid path for the beverage rising via the fitting tube, as well as an optional foot or head ring.

A beverage-dispensing device known from EP 1 293 476 [U.S. Pat. No. 6,820,775] with a beverage and gas valve that is usually mounted in the safety fitting is also divided by a bell-shaped separating wall into a bottom beverage chamber and a top pressurized gas chamber. Dispensing by gas pressure has the advantage of significantly longer shelf life for the beverage in the container compared to open, unpressurized output from the container with the entry of atmospheric oxygen. In containers that are not provided with a pressurized gas chamber, the gas is supplied from a high pressure gas bottle that is arranged outside of the beverage container and to which a pressure regulator is attached directly. This regulator is always set to the correct pressure for the beverage in question, e.g. 0.8 bar for wine with nitrogen and 2.1 bar for wheat beer with CO₂.

This container and containers known from EP-A-1 310 627 and GB-A-2 001 032 have upper and lower chambers, for instance produced from two shells, or three chambers, comprising an upper chamber and a lower chamber and having a tube between these chambers, these chambers being joined to one another by welding. Due to rough handling at times during transport, these containers or kegs must be protected from the stresses resulting from being dropped and bumped, which purpose is served by frame-like rings at the top and bottom, these rings also making it possible to stack the containers easily. Finally, very stringent hygiene requirements must be observed. Primarily for this reason and to protect against corrosion, containers having a body made of stainless steel or a stainless steel base and a polyurethane (PU) casing have been employed for decades; this makes the containers more expensive to produce, however.

The underlying object of the invention is therefore to create a generic beverage-dispensing device that is simple yet provides the meets the necessary high requirements regarding corrosion resistance and in particular hygiene and food-industry regulations and that enables variable connection for filling and tapping the beverage using a safety fitting.

This object is inventively attained in that the safety fitting is formed to protect the inner surface of the container with a liner inside the container and made of a sterile material. The liner, which preferably is sealed for example by welding or gluing with the safety fitting is a thin-walled bladder with a thickness of about 0.3 to 0.5 mm when the container parts are made of sheet steel. The liner ensures that in every situation, that is when the container is made of inexpensive low- or unalloyed tee, there is complete hygiene and corrosion protection. Since it lies against the inner surface of the container and makes an additional coating or similar protection unnecessary. Even cleaning of the container inner surface can be dispensed with.

The liner according to the invention can be blown up with CO₂ against the inner surface of the container. This forces any oxygen out of the container so that the beverage is not negatively influenced thereby.

Alternatively the liner can be installed in the container is under subatmospheric pressure. To this end about 0.4 to 0.6 bar is sufficient to create a flawless hygienic state. The initially flaccid liner expands when filled to press against the inner surface of the container.

The liner can preferably be made of an elastic material, for example of single-layer or an impermeable plastic laminate.

When the liner is not of elastic material it is preferred that it be made such that its maximum volume is larger than the fill volume of the container. This prevents any possibility of tearing.

For advantageous mounting of the safety fitting that in the simplest situation is pressed when pressed against the container upper part when installed, according to the invention an opening to the outside holds the safety fitting and has a bent-over rim and the safety fitting and the fitting tube and liner are secured on the bent-over rim by a connector part. The connector part can be a metallic clamp ring locked on the parts to be secured or the connector part can be a screw-on plastic ring.

For advantageous corrosion protection the two container parts are joined together at a weld seam provided with a cover strip. It can be a plastic film, a shrink film, or a prestretched film. Alternately the weld seam can be covered with paint.

The foot and/or head ring can according to a suggestion of the invention be made of plastic or of foam material and preferably is unitarily or integrally connected to the container or glued to it.

A preferred embodiment is that the head and/or foot ring is of sheet steel that is welded with the container parts. Preferably the foot and/or head ring is made of a short tube unitary with the upper or lower container part and thus forms a seamless extension thereof.

With the sheet-metal foot and head rings according to a preferred embodiment of the invention the outer upper or lower end of the head and foot rings are formed with a round groove that ends at a vertical end collar. Both the round groove and the bent-over rim ensure good stability at the end edges of the container.

With such a shape of the head and foot ring not only can the containers be stacked atop one another but there is the additional advantage that the end collar of the head ring is of somewhat greater diameter than the end collar of the foot ring and the end collars interfit in a double layer when the containers are stacked. When preferably the end collar of the foot ring is angled in at about 5° there is very good centering when the containers are stacked. The overlapping of the end collars where they are stacked further increases stability.

According to a preferred embodiment of the invention for filling the container and later tapping of the beverage by a user the safety fitting is provided with a fitting tube that is formed movably as an integrated part of the seal and that is upwardly closed in an annular opening of the outer housing by a plate-like tube end plate and is formed underneath the tube end plate with vent holes, the tube end plate forming an inner sealing seat for a seal ring that surrounds the fitting tube and that is adjacent an outer seal in the annular opening and shiftable against a spring force through steps.

The inventive inclusion of the fitting tube as a component of the seal and its cooperation with the seal ring, which can be pressed downward either alone or together with the fitting tube, makes it possible during filling at the brewery to downwardly displace or to press in only the seal ring until the in-flow cross-section for the beverage is exposed. This also applies to the vent holes for the fitting tube so that as a consequence of the filling, displaced oxygen or gas, like is for instance contained when a liner has first been inflated with CO₂ pressurized gas, can escape from the container interior. The flow paths for the beverage and the escaping oxygen and/or the gas are separated from one another by the part of the connector that depresses the seal ring.

When the filling process has ended and the connector has been disconnected, the seal ring then automatically returns to its starting position, due to spring action, in which starting position the safety fitting and thus the container are again sealed to the outside so that the container can be transported to the consumer.

For using or for tapping the beverage, in accordance with the invention the seal ring on the fitting tube is then moved through the first position to a second position that brings the fitting tube into a locked position, specifically when the tap head is placed or connected and actuated. Because the fitting tube is moved as well, and this is a smooth movement in the process, as soon as the seal ring has passed the vent holes the plate-like tube end plate consequently drops down commensurately from its starting position into the annular opening in the outer housing of the is safety fitting. The beverage, driven by pressurized gas, can rise in the fitting tube and travels via the vent holes and the chamber enclosed by the movable part of the tap head through the exposed annular opening to the tap.

For simultaneously displacing seal ring and fitting tube and for locking the fitting tube in its end position, the seal ring inventively has a catch that is associated with a stop edge on the fitting tube, whereby the fitting tube in the locked position is disposed in the interior of the outer housing with a projection under a stationary support that advantageously also supports the spring that actuates the seal ring. Due to the locked position, the fitting tube remains in this fixed position even if the container has been emptied and the tap head has been removed from the safety fitting. Once the tap head has been removed, only the seal ring moves back to its seat at the plate-like tube end plate under the force of the spring so that the vent holes in the tube surface of the fitting tube are closed. In this position it is possible to dispose of the container without any residual liquid being able to exit, but any residual gas that is present can still escape.

Additional features and details of the invention result from the claims and the following description of illustrated embodiments of the invention that are depicted in the drawings.

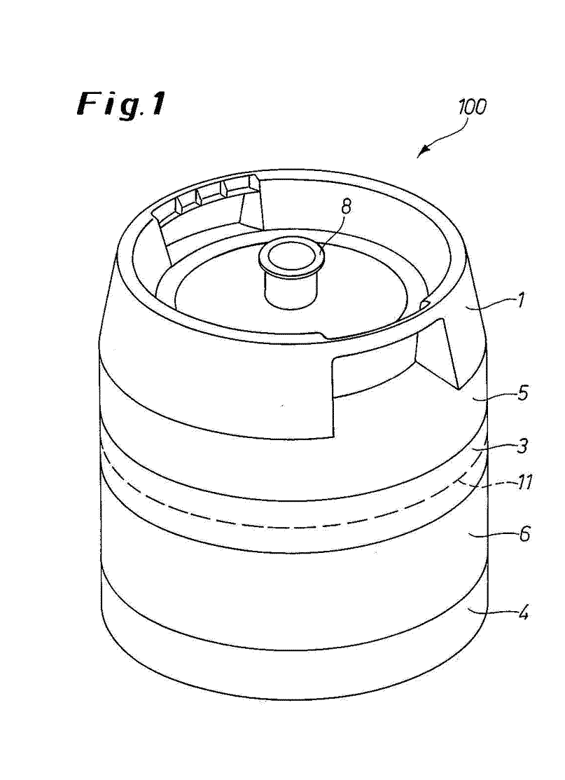

FIG. 1 is an overall perspective elevational view of a beverage-dispensing device that is formed as a disposable drum or of its container depicted without tap head or filling connector;

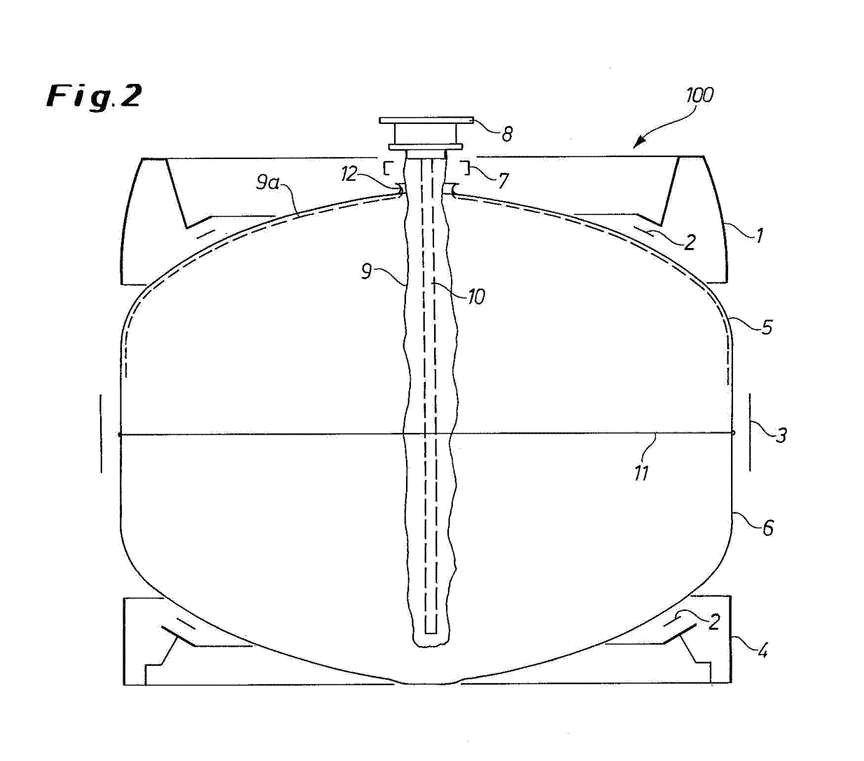

FIG. 2 is a schematic view of a liner added via the safety fitting to the interior of a container, the solid line indicating the position prior to and the broken line the position after flattening against the inner container walls;

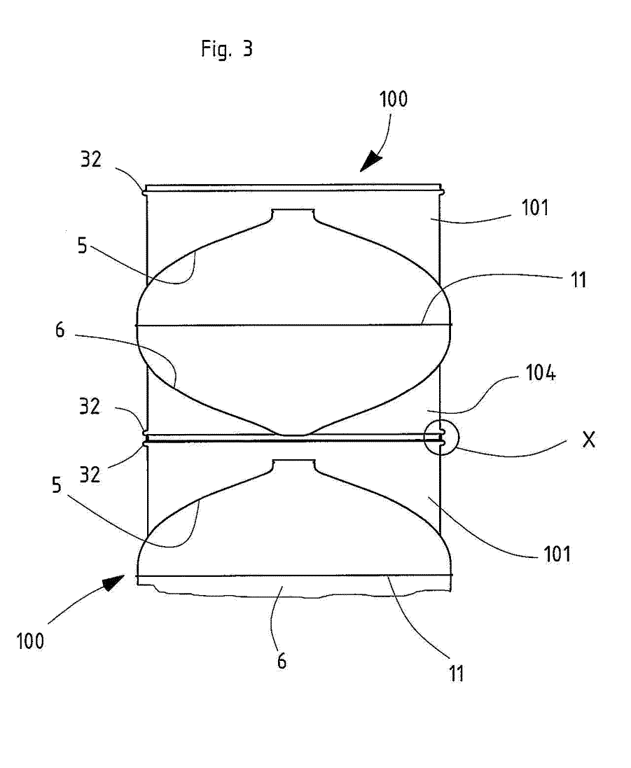

FIG. 3 shows the stacking position of containers, with a top container stacked on a bottom container that is only partly shown;

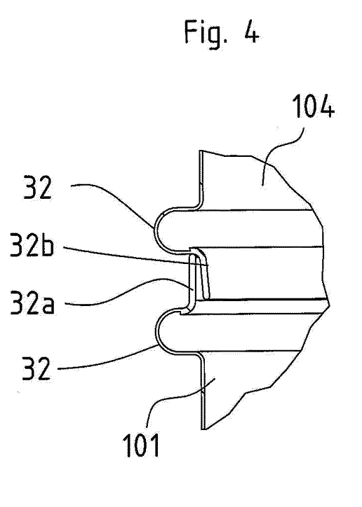

FIG. 4 is an enlarged view of the detail shown at X in FIG. 3;

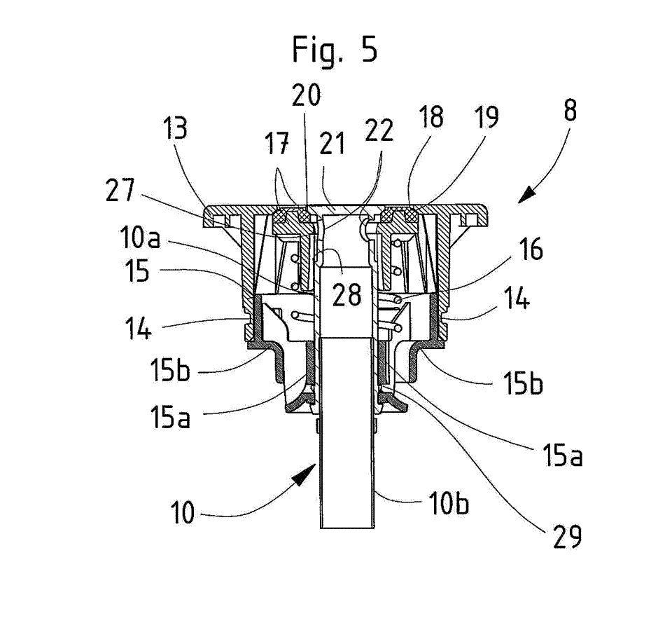

FIG. 5 is a longitudinal section of a safety fitting with its seal closed;

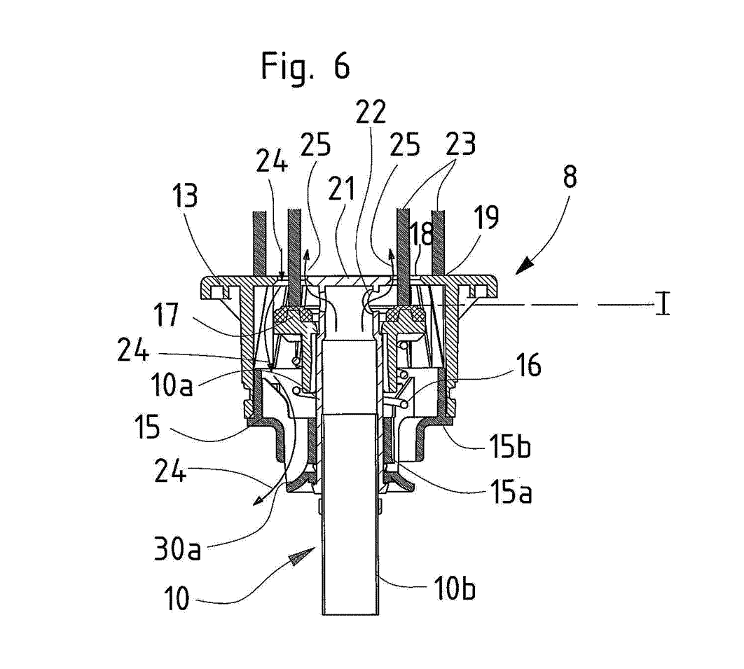

FIG. 6 is the safety fitting from FIG. 5 with opened seal in a first position for filling with beverage;

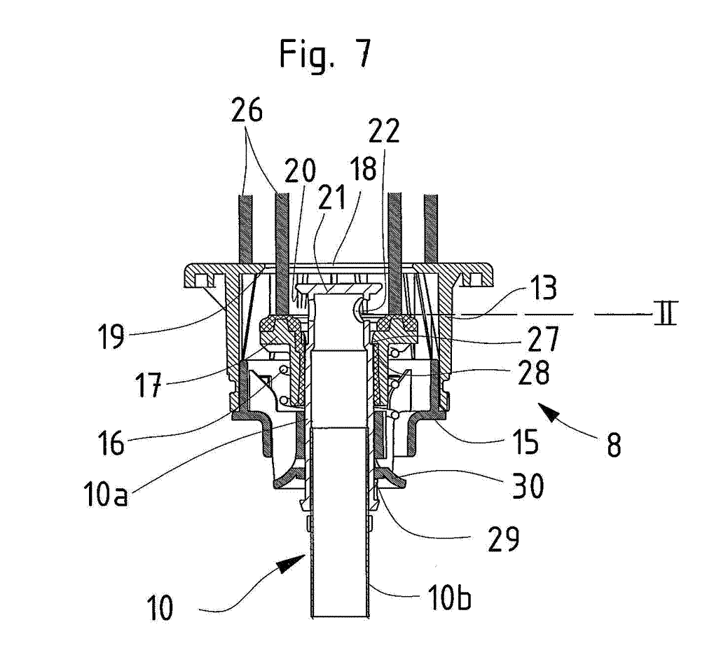

FIG. 7 is the safety fitting from FIG. 5 with opened seal in a second position for tapping the beverage; and,

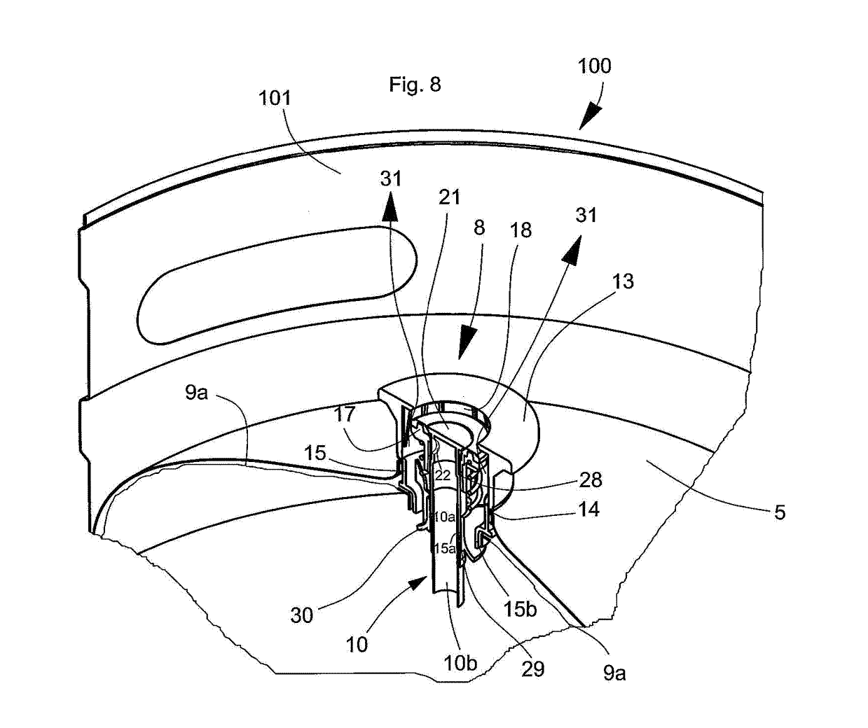

FIG. 8 shows a perspective longitudinal section of the safety fitting from FIG. 5 that has been added to a container or attached thereto, including a liner added with it, with a partial view of the container and closed position of the seal for disposal of the container.

The containers depicted in FIGS. 1 through 3 and a portion of which is depicted in FIG. 8 are all labeled 100, but their configurations and contours differ from one another. However, all of the containers 100 have multiple parts, and in the illustrated embodiments comprise a container top 5, a container bottom 6, and a head ring 1 and a foot ring 4, the latter two being made of metal in the embodiments in FIGS. 3 and 8 and being labeled 101 and 104 in those figures. The metal parts of the container 100 are joined to one another by welding, as shown by the weld seam 11 between the container top and the container bottom 5, 6 in FIGS. 1 through 3. All of the weld seams 11 can be provided with a coating paint or a cover strip 3, as shown in FIGS. 1 and 2, or the like. If the head and/or foot rings 1, 4 are produced from plastic or comprise foam material, they are joined to the container parts 5 and 6 in a positive and/or non-positive fit or are glued thereto, as indicated for instance in FIG. 2 with an adhesive spot 2.

The top of the container 100 is provided with a safety fitting 8 (not shown in FIG. 3) to which a connector can be coupled in a brewery for filling with a beverage or to which the user can connect a tap head. In accordance with FIG. 2, for fastening the safety fitting 8, an opening to the outside is formed with a bent-over rim 12 that is surrounded by a connecting piece 7, for instance a metal clamp ring or a plastic ring that can be screwed on. Thus simultaneously with mounting the safety fitting a liner 9a is installed inside the container that protects its inner wall and that after filling with a beverage or blown up with CO₂ lies in the dashed-line position of FIG. 2 on the inside surface of the container. In the embodiment in accordance with FIG. 8, the liner 9a is also retained between the container top 5 and the safety fitting 8. A riser or fitting tube 10 in the safety fitting 8 extends down in the container 100 nearly to its lower side.

One preferred embodiment of the safety fitting 8 is shown in various functional positions in FIGS. 5 through 8. The safety fitting 8 has an annular outer housing 13, which coacts with the walls of the container top 5 to clamp the liner 9; 9a (see FIG. 8) and is provided with an outwardly open circumferential groove 14 into which the bent-over rim 12 of the container mouth is fitted or pressed after first evacuating the space between the container walls and the liner. The outer housing 13 extends downward through a double-walled, stationary support 15 whose inner annular wall 15a and outer annular wall 15b form a flow passage, the inner annular wall 15a simultaneously also forming a guide for the fitting tube 10, which can be shift longitudinally therein.

In addition, a compression spring 16 is mounted in the double ring-shaped, stationary support 15 that actuates a 2K seal ring 17 made from two materials. The latter fits concentrically in an upper end annular opening 18 of the outer housing 13 that forms an outer sealing seat 19 for the seal ring 17. An inner sealing seat 20 is provided for the seal ring 17 by a plate-like tube end plate 21 that closes the upper end of the fitting tube 10.

The fitting tube 10 preferably comprises two parts, specifically an outer tube 10a, which is built into the safety fitting 8 and which is closed by the tube end plate 21, and a long inner tube 10b fitted therein, where necessary subsequently, i.e. on site when the safety fitting 8 is assembled. Formed below the tube end plate 21 in the wall of the fitting tube 10 or of the outer tube 10a are vent holes 22. In FIG. 5, they are covered by the seal ring 17, which is in the position it assumes after a container has been filled and is ready for transport.

The filling position prior to transport can be seen in FIG. 6. When a double ring-shaped filling connector 23 (indicated only schematically) is attached, the seal ring 17 is pressed downward on the fitting tube 10 or the outer tube 10a into a first filling position at level I, in which the vent holes 22 are unobstructed. Consequently, the beverage can flow in, as indicated by arrow 24. Simultaneously during this process oxygen and/or pressurized gas that is present in the container, for instance in the inflated liner 9a, can be displaced by the incoming beverage and can escape via the fitting tube 10 and the vent holes 22 and the annular opening 18, this flow path being limited by the tube end plate 21 and the inner ring of the filling connector 23 (see flow arrow 25). Filling is optimized by a guide edge 30a that in the illustrated embodiment is provided on the inner annular wall 15a of the support 15 and formed at the lower end of the safety fitting 8. The guide edge 30a channels the liquid stream 24 toward the container wall.

As soon as the container is filled, the connector 23 is disconnected and removed from the safety fitting 8 so that the seal ring 17, actuated by the compression spring 16, automatically returns to its closed, container transport position, shown in FIG. 5.

FIG. 7, where the sectional view has been turned 180° relative to that in FIGS. 5 and 6, illustrates the tap position. When a tap head 26 whose structure is comparable to the filling connector 23 in the brewery that is described above is connected (only indicated), the seal ring 17 is again moved downward, but this time when it passes the vent holes 22 it moves further and entrains the fitting tube 10 to move it into a locked position at level II, whereby as the fitting tube 10 is taken along its plate-like tube end plate 21 has correspondingly moved downward out of the annular opening 18 of the outer housing 13.

For entraining the fitting tube 10, the seal ring 17 has a catch lip 27 that is associated with a stop edge 28 on the fitting tube 10 or in this case its outer tube 10a. The seal ring 17 and the fitting tube 10 assume the locked position II as soon as a projection 29 locks with a stop part 30 of the stationary support 15. As long as the tap head 26 is attached or coupled and the container is tapped, the beverage can travel via the fitting tube 10 and the vent holes 22 to the tap. The fitting tube 10 cannot release itself from this locked position and move upward.

However, if the tap head 26 is removed, the compression spring 16 moves the seal ring 7 upward until it is positioned against the inner sealing seat 20 of the plate-like tube end plate 21. FIG. 8 shows this partially closed disposal position for the sealing of the safety fitting 8 after use. The seal ring 17 closes the vent holes 22 so that residual liquid remaining in the container cannot run out. However, the flow path for residual gas remains open so that it can escape even when the container is being disposed of or transported, as indicated by the flow arrow 31 in FIG. 8.

For stacking the containers 100, the latter, if equipped with metal head and foot rings 101, 104, as shown in FIGS. 3 and 4, can be provided at the free head and foot ring end with a reinforcing round bead 32 that connects to an essentially vertical, crimped end collar 32a, 32b. The end collar 32a of the head ring 101 is somewhat larger in diameter than the end collar 32b of the foot ring 104 so that the end collars 32a, 32b run parallel to one another in a double layer when the containers are stacked upon one another, so that there is clearly an additional increase in stability. The result is better centering for the containers that are stacked on one another if the end collars 32b are formed with a somewhat inward inclination, as shown in FIG. 4.

### REFERENCE LIST

1; 101 head ring
2 Adhesive point (adhesive ring or strip; hot melt; 2K adhesive or 1K adhesive)
3 Covering strip or coating
4; 104 Foot ring
5 Container top
6 Container bottom
7 Connector
8 Fitting (with closable opening for gas and liquid); safety fitting
9 Liner, evacuated
9a Liner, full
10 Fitting/riser tube
10a Outer tube
10b Inner tube
11 Weld seam
12 Bent-over rim (outer edge of container opening for the fitting 8)
13 Outer housing
14 Circumferential groove
15 Support
15a Inner annular wall
15b Outer annular wall
16 Compression spring
17 Seal ring
18 Annular opening
19 Outer sealing seat
20 Inner sealing seat
21 Plate-like tube end plate
22 Vent hole
23 Filling connector
24 Flow arrow
25 Flow arrow (displaced gas
26 Tap head
27 Catch lip
28 Stop edge
29 Projection
30 Stop part
31 Flow arrow
32 Round bead
32a, 32b End collars
I Filling position
II Locked position
100 Container

1. (canceled)

2. The disposable beverage-dispensing package according to claim 27 wherein the liner is sealingly mounted on the safety fitting.

3. The disposable beverage-dispensing package according to claim 27 wherein the container is formed with an opening to the outside holding the safety fitting and having a bent-over rim and the safety fitting and the fitting tube and liner are secured on the bent-over rim by a connector part.

4. The disposable beverage-dispensing package according to claim 3 wherein the connector part is a metallic clamp ring.

5. The disposable beverage-dispensing package according to claim 3 wherein the connector part is a screw-on plastic ring.

6. The disposable beverage-dispensing package according to claim 27 wherein the liner is filled with compressed CO₂ after installation and pressed against an inner surface of the container.

7. The disposable beverage-dispensing package according to claim 27 wherein the liner is under subatmospheric pressure.

8. The disposable beverage-dispensing package according to claim 27 wherein a maximum volume of the liner is somewhat larger than an internal volume of the container.

9. The disposable beverage-dispensing package according to claim 6 wherein the liner is of elastic material.

10. The disposable beverage-dispensing package according to claim 27 wherein the container parts are joined together at a weld seam provided with a cover strip.

11. The disposable beverage-dispensing package according to claim 27 wherein a weld seam joining the container parts together is provided with a paint covering.

12. The disposable beverage-dispensing package according to claim 27 wherein the container parts are made of sheet steel with a thickness of about 0.3 to 0.5 mm.

13. The disposable beverage-dispensing package according to claim 12 wherein the container parts are painted, hot-dip galvanized, or galvanically zinc-plated.

14. The disposable beverage-dispensing package according to claim 27 wherein the container parts are made of galvanized sheet metal or tinned sheet metal.

15. The disposable beverage-dispensing package according to claim 27, further comprising:
a head or foot ring made of plastic.

16. The disposable beverage-dispensing package according to claim 15 wherein the head or foot ring is made of foamed material.

17. The disposable beverage-dispensing package according to claim 27, further comprising
head and foot rings made of sheet steel.

18. The disposable beverage-dispensing package according to claim 17 wherein the head and the foot ring are made of a piece of tubing and joined integrally with the container parts.

19. The disposable beverage-dispensing package according to claim 17 wherein outer upper and lower ends of the head and foot rings are formed with respective round grooves that each end at a vertical end collar.

20. The disposable beverage-dispensing package according to claim 19 wherein the end collar of the head ring is of somewhat greater diameter than the end collar of the foot ring and the end collars interfit in a double layer when two of the containers are stacked.

21. The disposable beverage-dispensing package according to claim 20 wherein the end collar of the foot ring tapers downward.

22. (canceled)

23. The disposable beverage-dispensing package according to claim 28 wherein the seal ring is movable on the fitting tube from a first position blocking the vent holes and a second position coupled to and shiftable with the fitting tube.

24. The disposable beverage-dispensing package according to claim 23 wherein the seal ring has a catch lip that engages a stop edge on the fitting tube for entrainment in the second position, the fitting tube engaging in the second position with a projection under a stationary support inside the outer housing.

25. The disposable beverage-dispensing package according to claim 24 wherein the spring actuating the seal ring is braced against the support.

26. The disposable beverage-dispensing package according to claim 28 wherein a circumferential groove is formed in the outer housing in which a bent-over rim of the container opening is rolled or pressed for mounting the outer housing on the container.

27. A disposable beverage-dispensing package for compressed gas-operated dispensing of a beverage, the package comprising
a container,
a safety fitting on the container and having
an outer housing sleeve connected to the container,
a tube extending down inside the container inside the outer housing sleeve, the tube and outer housing forming a passage having an outer end opening outside the container and an inner end inside the container,
a seal shiftable on the tube between a closed position blocking the passage and an open position freeing the passage for filling and tapping the container, and
a spring biasing the seal into the closed position; and
a liner of a sterile material engaged with the outer housing and into which the inner end opens.

28. A disposable beverage-dispensing package for compressed gas-operated dispensing of a beverage, the package comprising
a container having an upwardly opened opening; and
a safety fitting on the container and having
an outer housing sleeve connected to the container,
a tube extending down inside the container inside the outer housing sleeve,
a tube end plate closing an upper end of the tube and oriented in the container opening, the tube being formed immediately below the plate with a horizontally throughgoing hole, the tube and outer housing forming a passage having an outer end opening outside the container around the plate and an inner end inside the container,
a seal ring shiftable on the tube between a closed position engaging the plate and blocking the outer passage end and an open position spaced downward from the plate and unblocking the outer passage end for filling and tapping the container, and
a spring biasing the seal into the closed position.
